(19) United States
(12) Patent Application Publication
(10) Pub. No.: US 2026/0116200 A1
(43) Pub. Date: Apr. 30, 2026

(54) ADAPTIVE HARDWARE SAFETY DISCONNECT SYSTEM

(71) Applicant: Rivian IP Holdings, LLC, Irvine, CA (US)

(72) Inventors: Sanjeewa Keven SUGATAPALA, Long Beach, CA (US); Kyle LOBO, Westchester, CA (US); Joseph Daniel HIMMELHEBER, Redondo Beach, CA (US); Shiju WANG, Irvine, CA (US); Steven HANG, Long Beach, CA (US); Long Phi HUYNH, Brea, CA (US); Baojin WANG, San Marcos, CA (US); Michael James HIBBARD, Long Beach, CA (US); Kshitij KULKARNI, Tustin, CA (US); Frederik Francois BOTES, Ontario, CA (US); Srinivasa Sastry GUNTUR, Charlotte, NC (US); Jason Adam SCHWARTZ, Yorba Linda, CA (US)

(21) Appl. No.: 19/216,574

(22) Filed: May 22, 2025

Related U.S. Application Data
(60) Provisional application No. 63/712,995, filed on Oct. 28, 2024.

(51) Int. Cl. B60L 3/04; B60R 16/033

(52) U.S. Cl. CPC B60L 3/04; B60R 16/033; B60L 2210/10

(57) ABSTRACT

An adaptive hardware safety disconnect system for electrified vehicles may utilize configurable hardware logic circuits to selectively disable vehicle systems, such as high voltage contactors, airbags, or low voltage power in a deterministic manner. A first disconnect mechanism may disable a first set of systems, while a second disconnect mechanism disables additional systems to fully power down the vehicle. The system can be configured for different use cases such as emergency response, servicing, and development testing while using common hardware components.

### CROSS-REFERENCE TO RELATED APPLICATIONS

The present application claims the benefit of U.S. Provisional Application No. 63/712,995, entitled “Adaptive Hardware Safety Disconnect System”, filed Oct. 28, 2024, the entirety of which is incorporated herein for reference.

### INTRODUCTION

This application is directed to safety systems for electric vehicles, and more specifically to an adaptive hardware-based system for selectively disconnecting power and disabling critical systems in vehicles.

### SUMMARY

The disclosed subject matter provides for zonal architecture for power distribution and other designs thereof that may allow for safety disconnect of electric vehicles. The system may use a configurable circuit to selectively disable vehicle systems, such as high voltage contactors, airbags, and low voltage power in a deterministic manner.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates an example overhead view of a vehicle with zonal power distribution as described herein.

FIG. 1B illustrates an example side view of a vehicle with zonal power distribution as described herein.

FIG. 2A illustrate an example block diagram that may include a plurality of electronic control units (ECUs).

FIG. 2B illustrates an example block diagram that may include a plurality of ECUs.

FIG. 2C illustrates an example detailed portion of the block diagram of FIG. 2B.

FIG. 2D illustrates an example detailed portion of the block diagram of FIG. 2B.

FIG. 3A illustrates an example high-level system diagram of an adaptive hardware safety disconnect system.

FIG. 3B illustrates an example high-level system diagram of an adaptive hardware safety disconnect system.

FIG. 3C illustrates an example high-level system diagram of an adaptive hardware safety disconnect system.

FIG. 4A illustrates an example high-level system diagram of an adaptive hardware safety disconnect system.

FIG. 4B illustrates an example high-level system diagram of an adaptive hardware safety disconnect system.

FIG. 4C illustrates an example high-level system diagram of an adaptive hardware safety disconnect system.

FIG. 5 illustrates an example high-level system diagram of an adaptive hardware safety disconnect system for vehicle with an overlayed flow as further described herein.

FIG. 6 illustrates an example method for power disconnect according to an embodiment.

FIG. 7 illustrates an example method for disconnecting power in accordance with an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Conventional electric vehicle power systems often use distributed components, leading to increased complexity, wiring, and reduced reliability. There is a need for more integrated and centralized architectures to improve efficiency, reduce costs, enhance safety, or provide functional redundancy. Systems often struggle with optimal power distribution, safety during charging, and efficient packaging of components. The disclosed subject matter may address these challenges through a comprehensive, integrated approach.

The disclosed subject matter provides a safety disconnect system for vehicles. The system may utilize a configurable circuit to selectively disable vehicle systems, such as high voltage contactors, airbags, or low voltage power, in a deterministic manner that may not rely on software. The system may be configured in different modes to support production vehicles, development vehicles, or other use cases while using common core hardware. The system may be configured for different use cases such as emergency response, vehicle servicing, or vehicle development testing. The system may simplify the vehicle development process by employing common hardware that can be configured for testing or production. Additionally, the system may support fireman's safety shutdown, vehicle service operations, and development reset and power-down functionalities. The disclosed subject matter may improve safety, flexibility, or cost-effectiveness compared to conventional approaches.

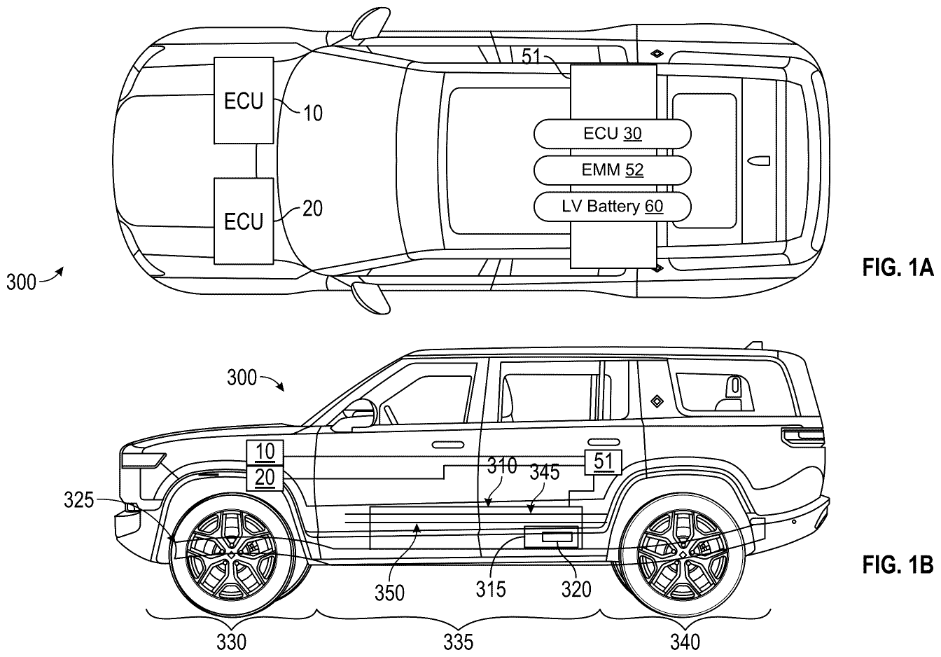

FIG. 1A illustrates an example overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), power management compartment 51 (which may also be referred to as a treehouse), or low voltage (LV) battery 60 (e.g., 9V-16V battery), among other things. As further described herein, ECU 10 may operate components on a first side of a longitudinal axis of vehicle 300, while the ECU 20 may operate components on a second side of the longitudinal axis. The longitudinal axis may be defined as an imaginary line running from the front of vehicle 300 to the rear along its center, dividing vehicle 300 into the first (e.g., left) and second (e.g., right) sides. ECU 30 may operate components at the rear of vehicle 300. ECU 30 may be located within power management compartment 51.

Power management compartment 51 may include ECU 30, energy management module (EMM) 52, or LV battery 60 (e.g., 9V to 16V), among other components. Power management compartment 51 may be a structure that includes power management related components located in a rear of vehicle 300, such as under the second row seat or trunk of vehicle 300. Power management compartment 51 may be the volume of a traditional gas tank and package multiple components as disclosed herein. Power management compartment 51 components may include ECU 30 with left and right microcontroller units (MCUs) (e.g., MCU 65 or MCU 66), a DC-DC converter (e.g., DC-DC 50), LV battery 60, or an isolation switch (ISOSW) (e.g., fault isolation system 11), among other things. DCDC 50 may be located within EMM 52. ECU 30 may integrate battery management system (BMS) and zonal control functions, managing power distribution between the DC-DC bus and battery bus. Power management compartment 51 may connect with ECU 10 and ECU 20, forming the backbone of the power architecture of vehicle 300. This design may reduce high current feeds from 7 or more in other architectures to just 3, for example, in the disclosed architecture, while eliminating the need for diode ORing, among other things. Power management compartment 51 architecture may provide end-to-end functional redundancy and may enable simplified LV battery management through a single battery feed. This centralized location of Power management compartment 51 may reduce the likelihood of damage to multiple systems simultaneously in severe crash scenarios, potentially improving occupant safety and post-crash response capabilities. Thermal management may be efficient through the centralization of high-power components. This approach may allow for more efficient packaging and reduced system complexity.

FIG. 1B illustrates an example side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. As further described herein, ECU 10 (also may be referred to herein as cast zone controller-EZC 10), ECU 20 (also may be referred to herein as west zone controller-WZC), or ECU 30 (also may be referred to herein as south zone controller-SZC) may be communicatively connected with or have power distributed with each other and may be functionally redundant for power or other operations of electronic components of vehicle 300.

In one or more implementations, vehicle 300 may be an electric vehicle having one or more electric motors that drive wheels of the vehicle 300 using electric power from HV battery pack 310. In one or more implementations, vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 300 may be implemented as a truck (e.g., a pickup truck) having a battery pack 310. As shown, HV battery pack 310 may include one or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 1B, vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portions 330, center body portion 335, or the rear portion 340). As shown, HV battery pack 310 may include or be electrically coupled with one or more one busbars (e.g., one or more current collector elements). In the example of FIG. 1B, vehicle 300 includes a first busbar 345 and a second busbar 350, either or both of which may include electrically conductive material to connect or otherwise electrically couple battery module(s) 315 or the battery cell(s) 320 with other electrical components of vehicle 300 to provide electrical power to various systems or components of vehicle 300.

In other implementations, vehicle 300 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, or any other movable apparatus having a battery pack 310 (e.g., that powers the propulsion or drive components of the moveable apparatus).

The disclosed multi-zonal architecture may allow for reduced wiring when compared to other architectures. Shorter wires may provide for less mass and therefore vehicle 300 may weigh less. While wire length generally may not significantly affect cost for small gauge wires, it may influence the overall mass and flexibility of the harness. Longer wires may increase harness bulk, potentially complicating installation due to reduced flexibility.

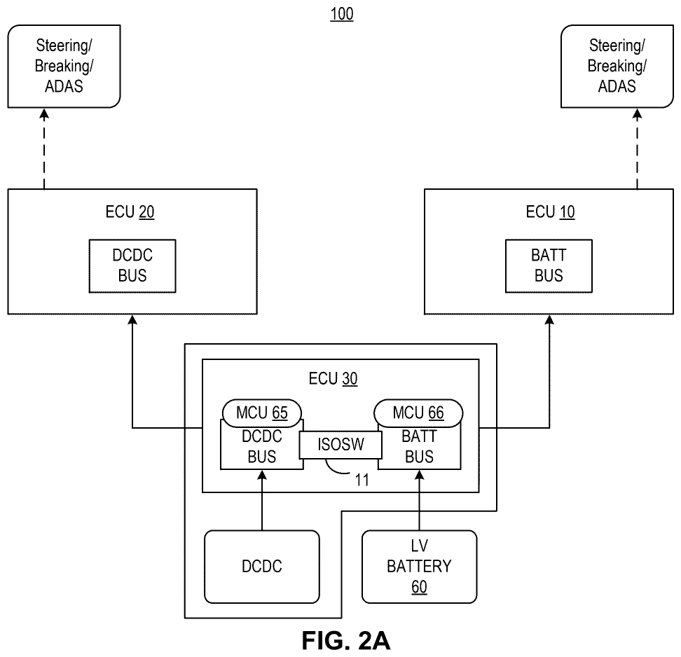

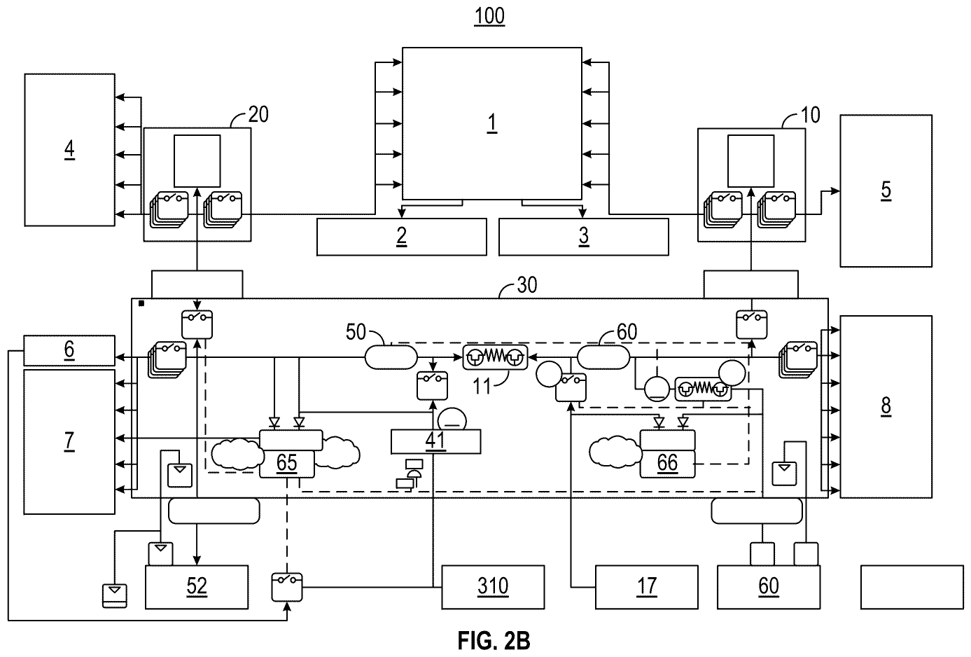

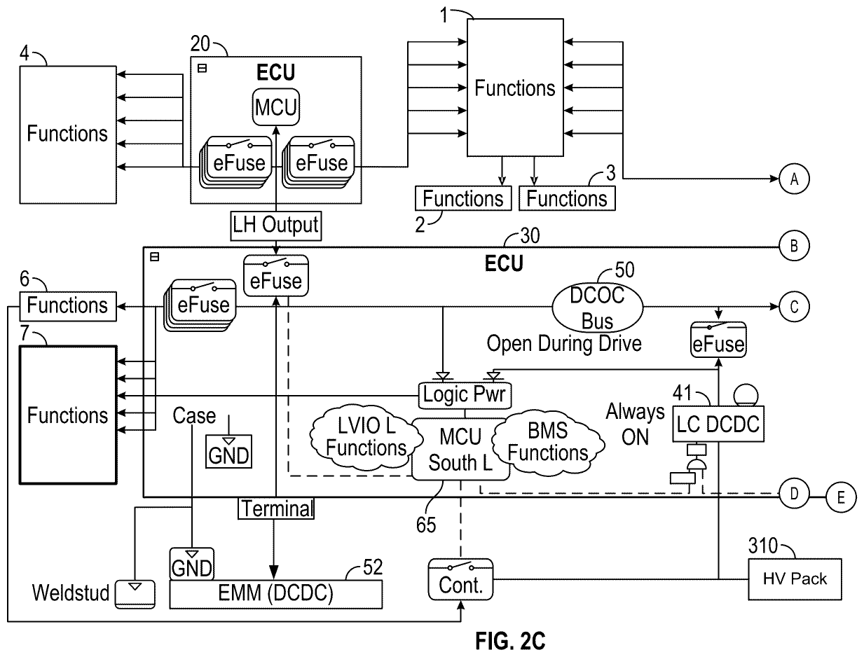

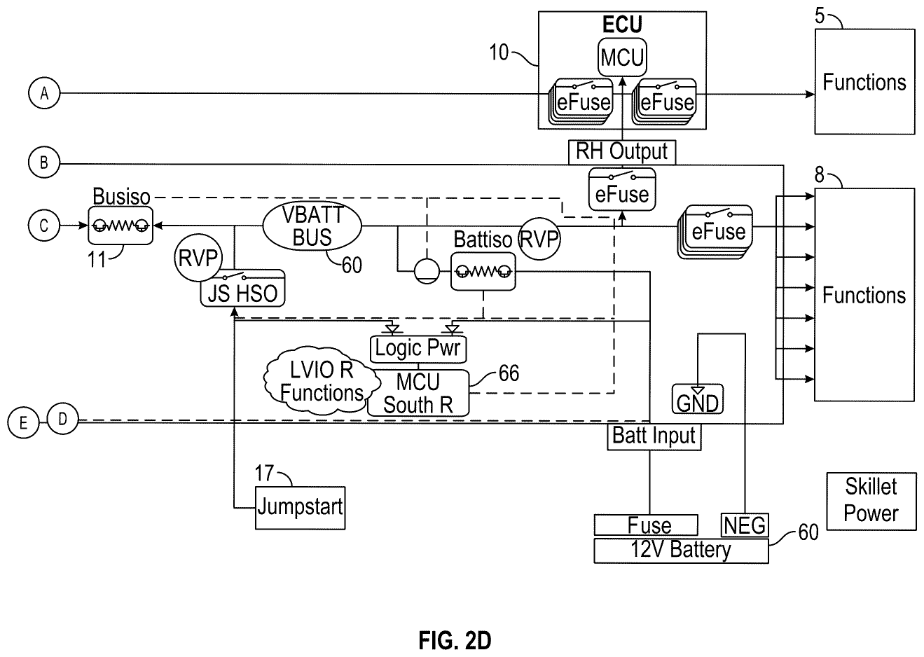

FIG. 2A and FIG. 2B illustrate exemplary block diagrams of system 100 that may include a plurality of ECUs of vehicle 300. An ECU is an embedded system that may control one or more of the electrical systems or subsystems in a vehicle, such as steering, breaking, advanced driver assistance system (ADAS), or the like. The positioning and connections of ECU 10, ECU 20, or ECU 30 may provide for a level of redundancy for faults, which may be caused by collisions or other malfunctions. The design of system 100 may allow vehicle 300 to safely operate for a period after the fault, such as being able to drive vehicle 300 (e.g., steer, brake, or accelerate) to a safe position off of a roadway or being able to operate electronic controlled functions (e.g., door latches) of vehicle 300, among other things. As shown, ECU 10, ECU 20, or ECU 30 may be connected with DCDC 50 (also referred herein as DCDC bus 50) to operate DCDC loads and a low voltage (LV) battery 60 (e.g., 9V-16V battery or LV battery bus 60) to operate LV battery loads.

There may be different types of operations such as post-crash operation, sleep operation, jumpstart operation, manufacturing power operation, DCDC fault operation, LV battery fault operation, or normal operation associated with driving, among others. FIG. 2B illustrates an exemplary block diagram of system 100 in normal operation associated with driving. FIG. 2C and FIG. 2D are zoomed in portions of system 100 of FIG. 2B, with example information regarding currents, voltages, or other information. In an example, one or more ECUs (e.g., ECU 30) may include a fault isolation system 11. Fault isolation system 11 may include an isolation switch. In some configurations, in consideration of safety, only one ECU (e.g., ECU 30) may include fault isolation system 11. There may be a common bus that allows for bidirectional power to be transmitted to and from LV battery 60 that may be a function of using fault isolation system 11. In the event of a failure of the DCDC 50 (within EMM 52) or LV battery 60, the common bus will retain operation (e.g., will be available).

With continued reference to FIG. 2B through FIG. 2D, each ECU may have on or more dedicated functions that may be powered by DCDC 50, LV battery 60, or LV DCDC 41 (also referred herein as standby power or mini DCDC). ECU 10 may operate or connect with (e.g., communication or power) functions 1, functions 2, functions 3, and functions 5. Functions 1 may include functions such as first row universal serial bus, or electronic stability program (ESP), among other things. Functions 2 may include functions such as right door latch, passenger seat motor, right headlamp, alarm module, or frunk latch, among other things. In this example, functions 1, functions 2, functions 3, or functions 5 of ECU 10 may be powered by DCDC 50 (which may be the primary power) or LV battery 60 (which may be the secondary power). ECU 10 may be located on the right front of vehicle 300 and therefore may operate functions primarily for the right portion of vehicle 300.

As shown in FIG. 2B, ECU 20 may operate functions 1, functions 2, functions 3, or functions 4. Functions 1 may include functions such as front suspension valves, or autonomy control module, among other things. Functions 4 may include functions such as steering angle sensor, front wiper motor, left door latches, left headlamp, exterior near field communication (NFC), or on-board diagnostics (OBD) port, among other things. Functions 1 or functions 2 may include functions such as electric power assisted steering (EPAS), charge port door, interior NFC, or electric powered assisted breaking, among other things. In this example, functions 1, functions 2, functions 3, or functions 4 of ECU 20 may be powered by DCDC 50 (which may be the primary power) or LV battery 60 (which may be the secondary power). ECU 20 may be located on the left front of vehicle 300 and therefore may operate functions primarily for the left portion of vehicle 300.

As shown in FIG. 2B, ECU 30 may operate functions 6, functions 7, functions 8, or jumpstart functions. ECU 30 may be connected with jumpstart access 17. Jumpstart access 17 may allow an external power source (e.g., jumpstart pack) to connect with ECU 30 in order to jumpstart electronic functions of vehicle 300, such as when LV battery 60 is depleted. As further described herein, jumpstart access 17 may have multiple routes. Functions 6 may include functions such as main contactor or DCFC contactor. Functions 7 or functions 8 may include functions such as rear vehicle access system sensors, liftgate latch, trailer brake, right lamp rear, left lamp rear, right trailer brake lamp, rear suspension valves, DCDC logic power, BMS voltage/isolation monitoring, park lock, HV pack shunt monitor, radio farm, charge port PC/IO, rear radar, or ethernet components, among other things. In this example, functions 6, 7, or 8 of ECU 30 may be powered by DCDC 50 (which may be the primary power) or LV battery 60 (which may be the secondary power). ECU 30 may be located on the rear of vehicle 300 (e.g., under a rear seat) and therefore may operate functions primarily for the rear portion of vehicle 300.

System 100 may include a battery management system (BMS). The BMS may be located at or near HV battery pack 310, which LV DCDC 41 converts the HV DC to a lower voltage, such as 14V. LV DCDC 41 may help reduce the need for LV battery 60 for some operations, such as when vehicle 300 is in standby mode (e.g., parked). It is contemplated that the functions disclosed herein (e.g., functions 1 through functions 8) may be controlled by other ECUs or powered by any of the listed power sources.

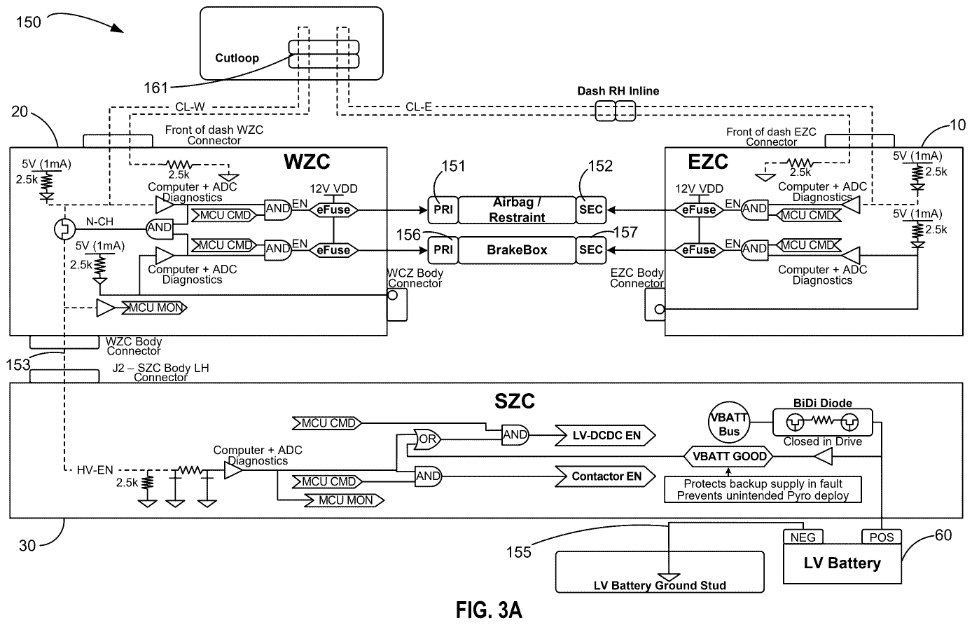

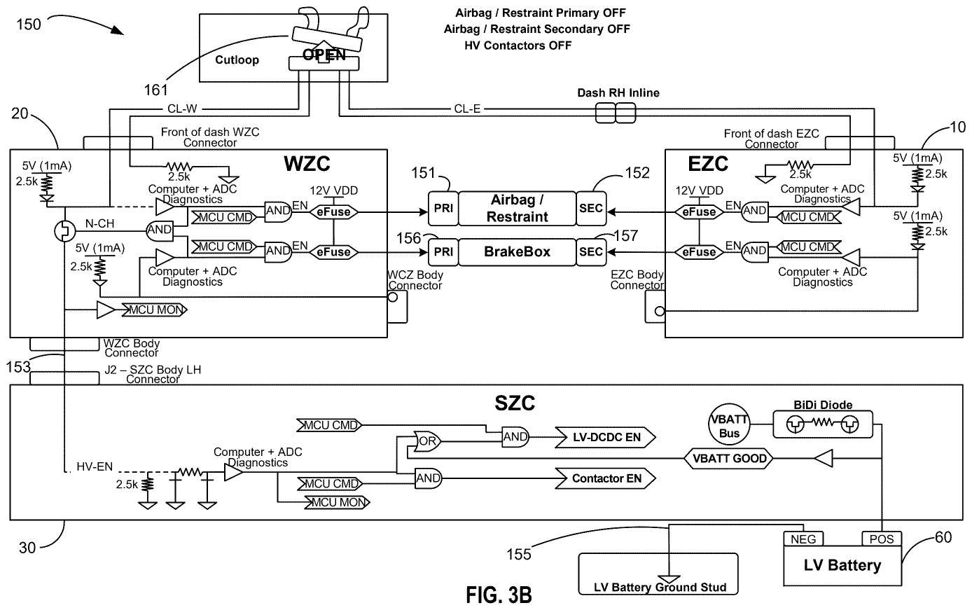

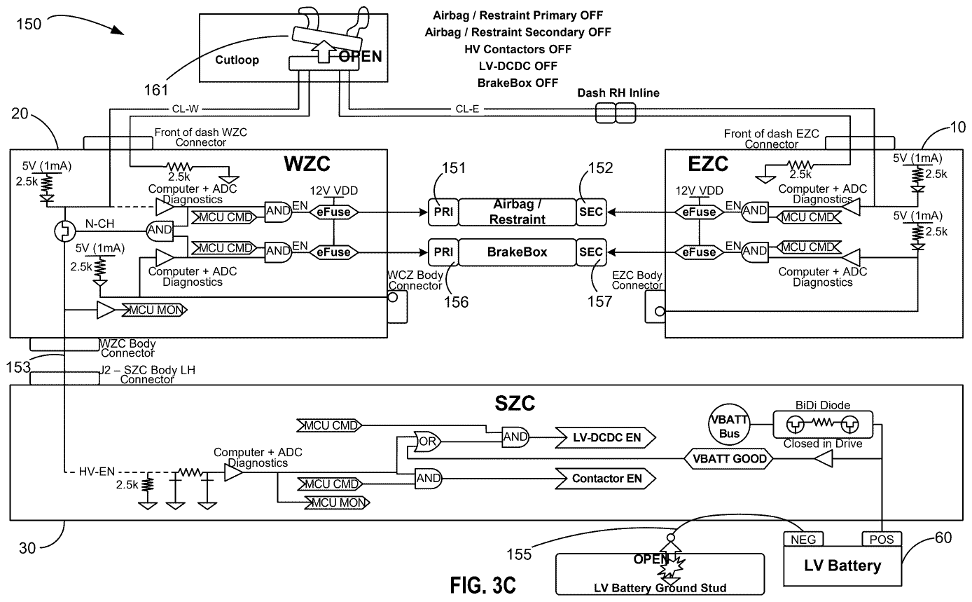

FIG. 3A illustrates an example high-level system diagram of an adaptive hardware safety disconnect system 150 for vehicle 300. Vehicle 300 may be a production electric vehicle, which may include ECU 10, ECU 20, ECU 30, LV battery 60, cut loop 161, and connection 153 from ECU 20 to ECU 30. ECU 10, ECU 20, and ECU 30 may be interconnected by discrete hardware signal lines. The controllers may include hardware logic circuits configured to implement the safety disconnect functionality. ECU 20 may include input buffers to detect cut loop and E-stop signals. Logic gates may combine the inputs to generate the appropriate disable signals. ECU 30 may include similar input detection and logic to control the low voltage systems. For example, ECU 30 may use a combination of AND and OR gates to ensure that LV DC-DC 41 is only disabled when the appropriate conditions are met. Logic gates may combine the inputs to generate the appropriate disable signals. For example, an OR gate might be used to trigger the airbag disable signal if the cut loop or E-stop is activated. An AND gate might be used to generate the high voltage or LV DCDC disable signal only if both the cut loop is activated and the low voltage battery is disconnected.

By implementing the safety-critical disconnection functionality in hardware logic, deterministic behavior is ensured without relying on potentially unreliable software. The adaptive nature of this system may allow it to be modified for different vehicle models or different types of electric vehicles (e.g., passenger cars, buses, trucks) with minimal changes to the core hardware. This flexibility may lead to significant cost savings in development or manufacturing.

Cut loop 161 provides an externally accessible emergency disconnect that may be activated by first responders, service personnel, or others. As shown in FIG. 3A, cut loop 161 may be closed and therefore power is enabled to travel throughout vehicle 300 as designed. As shown in FIG. 3B, cut loop 161 may be opened and therefore may be designed to cutoff high voltage power throughout vehicle 300, such as with ECU 10, ECU 20, and ECU 30. LV battery 60 and LV DCDC 41 may still be enabled. In this example, restraints control module (RCM) (e.g., airbags) primary 151, RCM secondary 152, and HV contactors may be off. As shown in FIG. 3C, cut loop 161 remains open and also ground terminal 155 of LV battery 60 may be disconnected. This disconnect of LV battery 60 further turns off the remaining power to vehicle 300, which may include additionally turning off LV DCDC 41 and brake box primary 156 and brake box secondary 157. Brake box may be associated with the stability system.

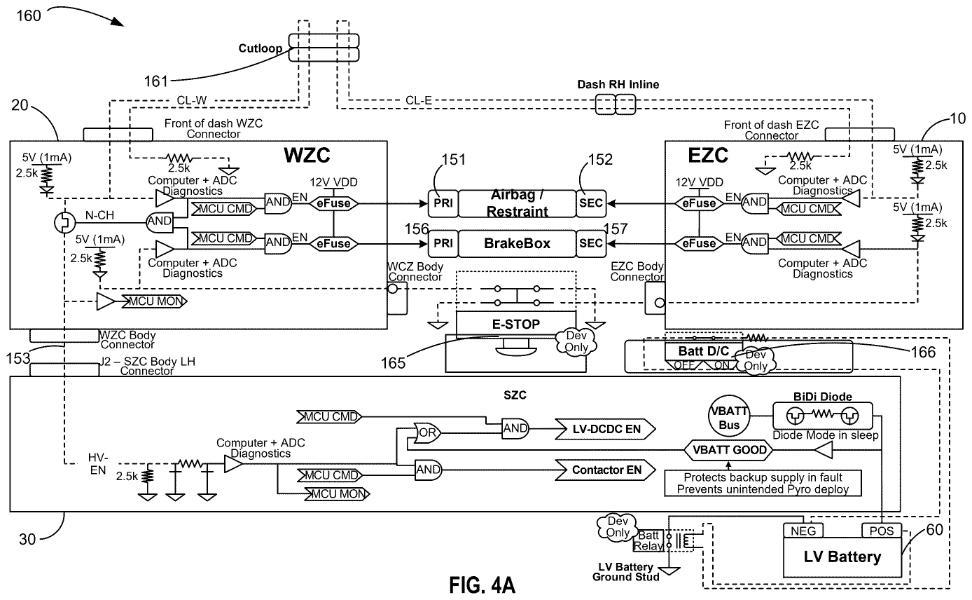

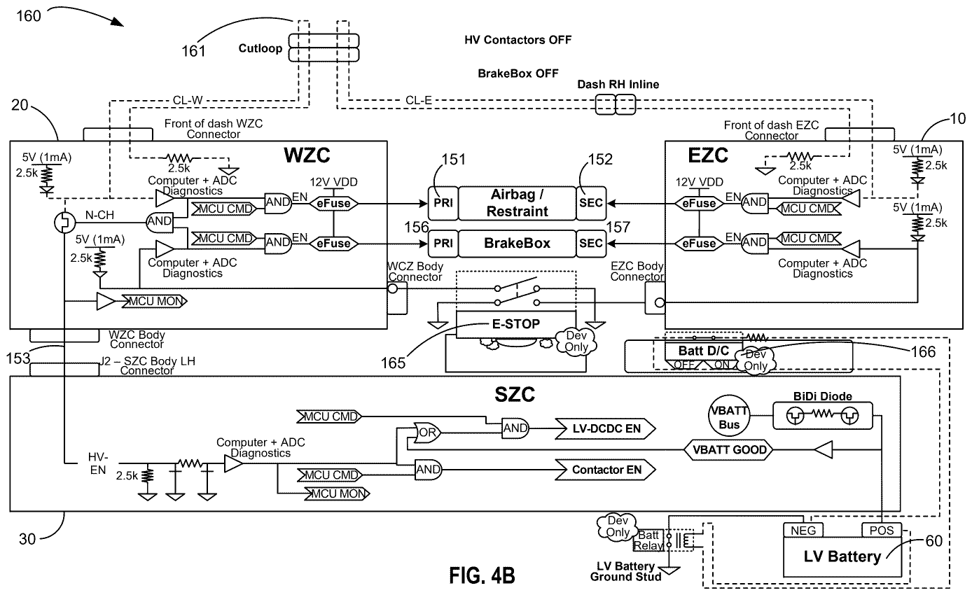

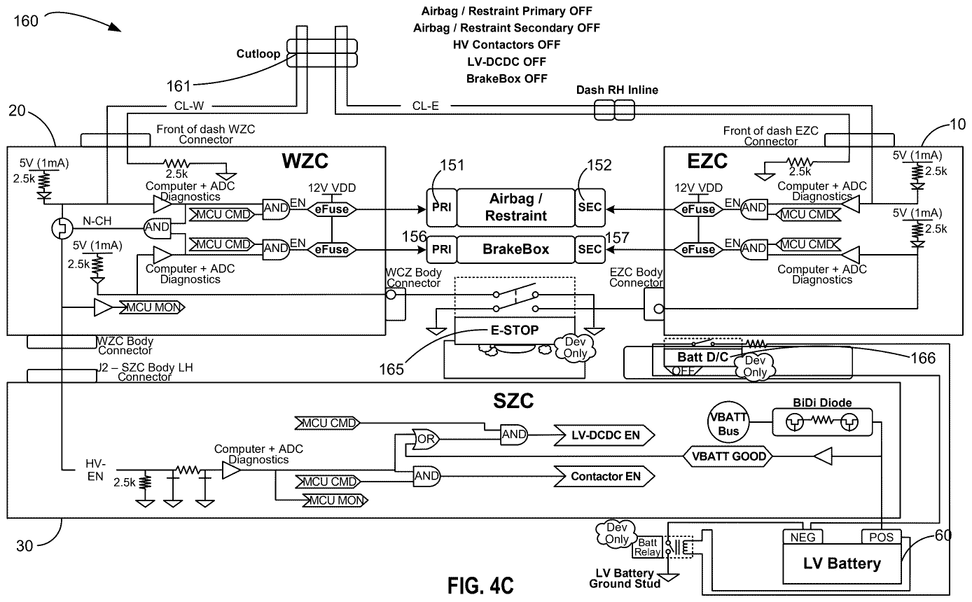

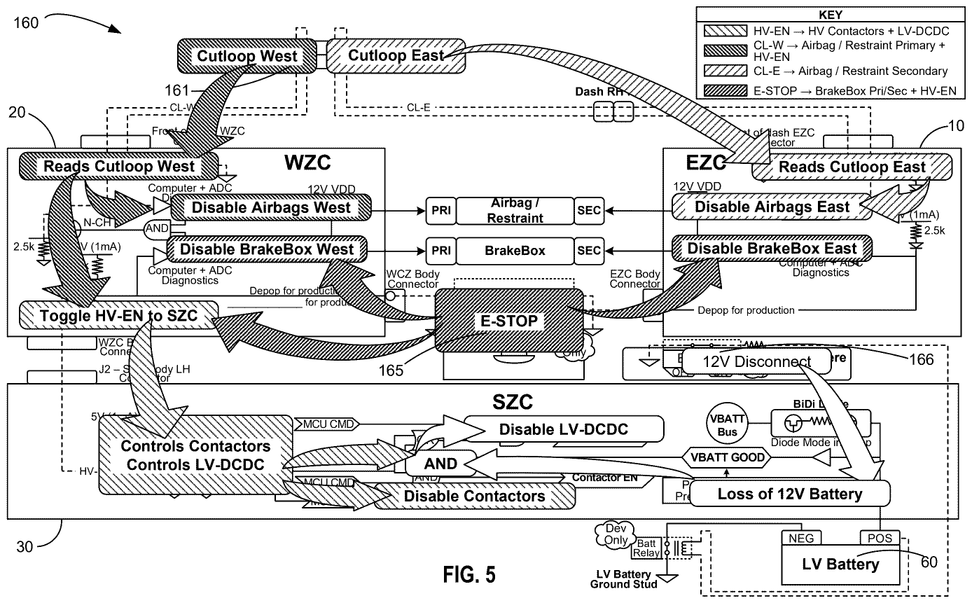

FIG. 4A illustrates an example high-level system diagram of an adaptive hardware safety disconnect system 150 for vehicle 300. Vehicle 300 may be a development or other electric vehicle, which may include ECU 10, ECU 20, ECU 30, LV battery 60, cut loop 161, connection 153 from ECU 20 to ECU 30, emergency stop (E-stop) 165, and LV battery disconnect switch 166. Cut loop 161 may be closed and therefore power is enabled to travel throughout vehicle 300 as designed. As shown in FIG. 4B, cut loop 161 may be closed, but E-stop 165 may be engaged (e.g., pressed). Based on E-stop 165 being engaged as disclosed, there may be a cutoff of high voltage power throughout vehicle 300, such as with ECU 10, ECU 20, and ECU 30. LV battery 60 and LV DCDC 41 may still be enabled. In this example, brake box primary 156, brake box secondary 157, and HV contactors may be off. As shown in FIG. 4C, cut loop 161 remains closed, E-stop may be engaged, and also LV battery disconnect switch 166 may be turned to the off position. LV battery disconnect switch 166 being in the off position further turns off the remaining power to vehicle 300, which may include additionally turning off LV DCDC 41, RCM primary 151, and RCM secondary 152. FIG. 5 illustrates an example high-level system diagram of an adaptive hardware safety disconnect system 150 for vehicle 300 with an overlayed flow as further described herein, such as FIG. 3A-FIG. 4C.

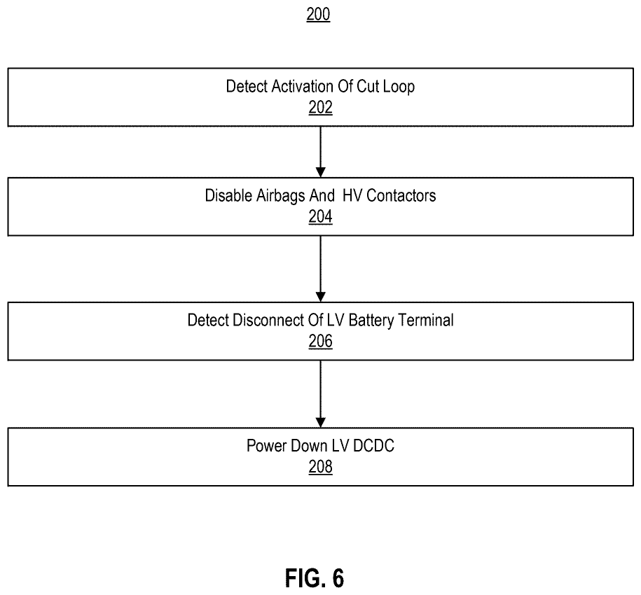

FIG. 6 illustrates an example method 200 for power disconnect according to an embodiment. This method may allow for rapid or reliable disabling of systems.

At step 202, activation of cut loop 161 is detected, for example by the ECU 20 sensing an open circuit. The cut loop 161 may be located in an accessible location, such as under the hood of vehicle 300. In an example, scenario cut loop 161 may be used to allow first responders or service technicians to quickly initiate a safety shutdown process.

At step 204, in response to activation of cut loop 161, power may be disabled to the airbag systems (e.g., RCM 151 or RCM 152) and the high voltage contactors may be opened using hardware logic circuits in the zone controllers. This step 204 may be used for making vehicle 300 safe in an emergency situation. Disabling the airbag systems may prevent unintended deployment during rescue or service operations, while opening HV contactors may isolate the high voltage battery, significantly reducing the risk of electrical hazards.

The hardware logic circuits may ensure that this disabling process occurs rapidly and reliably, without dependence on potentially vulnerable software systems. ECU 20 may directly disable the airbag systems by cutting power to the RCM 151 or RCM 152. Near or at the same time a signal may be sent ECU 30 to open HV contactors.

At step 206, disconnection of the low voltage battery terminal may be detected, for example by ECU 30 sensing loss of battery voltage. This step may allow for complete power-down of the electrical systems of vehicle 300. The disconnection of LV battery 60 may be performed manually by a service technician or automatically as part of a comprehensive shutdown sequence.

At step 208, in response to the disconnect of LV battery 60, power to the LV DCDC 41 may be disabled using hardware logic. This action may fully power down the systems of vehicle 300, ensuring that no residual power remains in the vehicle's electrical network. The hardware logic in the ECU 30 may directly cut the enable signal to LV DC-DC 41, ensuring it stops providing power to the low voltage systems of vehicle 300.

This two-stage shutdown process may ensure that critical safety systems are disabled first, followed by a complete power-down of the electrical systems. The use of hardware logic circuits throughout this process helps ensure deterministic behavior and rapid response times, which may be crucial in emergency situations.

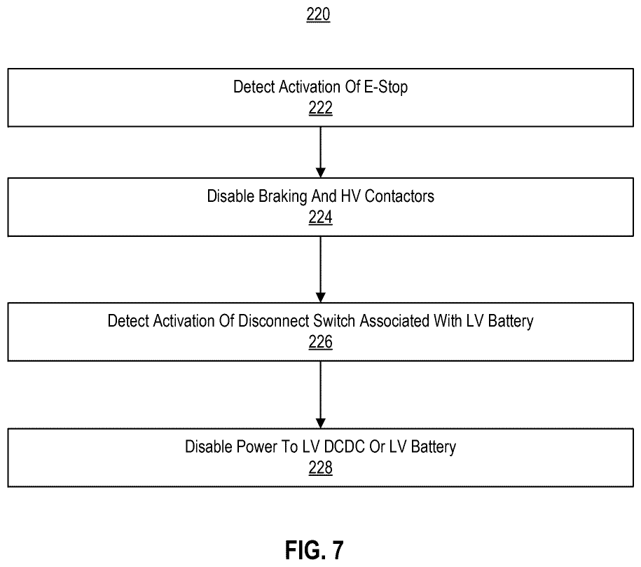

FIG. 7 illustrates an example method 220 for disconnecting power in accordance with an embodiment disclosed herein. Method 200 may be tailored for use during vehicle development and testing, where rapid system shutdown capabilities are crucial for safety and diagnostic purposes, but applicable to other scenarios as well.

At step 222, activation of E-stop switch 165 may be detected. E-stop 165 may be prominently placed, easily accessible switch in the vehicle cabin, allowing test drivers to quickly initiate a shutdown sequence if they encounter any issues during testing.

At step 224, in response to activation of E-stop 165, power may be disabled to the braking system (e.g., brake box 156 or brake box 157) and HV contactors may be opened using hardware logic circuits. This step may allow a test driver to quickly disable propulsion and braking during testing, which may be crucial if any unexpected behavior is encountered.

The hardware logic in ECU 10 or ECU 20 may work in concert to achieve this. The ECU 10 may be responsible for disabling the braking system, while ECU 20 may signal the ECU 30 to open the high voltage contactors. This distributed approach may allow for redundancy or faster response times.

Disabling the braking system in this context may not mean removing all braking capability, but rather disabling power to electric brake actuators or other electronically controlled braking components. This action may be taken to prevent any potential for unintended brake application due to system malfunctions during testing.

At step 226, activation of LV battery disconnect switch 166 may be detected. LV battery disconnect switch 166 may provide an easily accessible way for test personnel to completely shut down electrical systems of vehicle 300. In an example, a production vehicle may be configured to disconnect LV battery 60, while the development vehicle which may need to use such disconnects relatively often may include a dedicated switch (LV battery disconnect switch 166) for this purpose.

At step 228, in response to the activation of LV battery disconnect switch 166, power to the LV DCDC 41 and LV battery 60 may be disabled to fully power down vehicle 300. As in other scenarios, this step may ensure that all vehicle systems are completely de-energized. ECU 30 may be responsible for detecting the switch activation and subsequently disabling LV battery 60 and LV DCD 41.

Method 220 may provide more granular control over the shutdown process, allowing for disablement of specific systems (e.g., propulsion or braking) without necessarily powering down the entire vehicle. This may be useful for diagnosing issues or testing specific components. However, the option for a complete power-down may still be available when needed. It is contemplated that one or more combinations of the disclosed methods may be implemented.

The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone specific electronic control units (ECUs). The information (e.g., voltage, current, resistance, or proposed functionality), as disclosed herein in the figures and text, is provided for illustrative purposes and other scenarios are contemplated herein.

Methods, systems, and apparatuses with regard to disconnecting power in vehicles are disclosed herein. In an example, method, system, or electric vehicle may provide for detecting activation of a first disconnect mechanism and, in response, disabling power to a first set of vehicle systems using hardware logic circuits. The method, system, or electric vehicle may further include detecting activation of a second disconnect mechanism and, in response, disabling power to a second set of vehicle systems using hardware logic circuits to fully power down the vehicle. The first disconnect mechanism may include a cut loop connector or an emergency stop switch, where the first set of vehicle systems may include airbag systems, high voltage contactors, or a braking system. The second disconnect mechanism may include disconnection of a low voltage battery terminal or a low voltage battery disconnect switch, in which the second set of vehicle systems may include a low voltage DC-DC converter. The hardware logic circuits may be implemented in a plurality of interconnected zone controllers, which may include an East zone controller, a West zone controller, and a South zone controller. The disabling of power to the first set of vehicle systems and the second set of vehicle systems may occur without software intervention. The hardware logic circuits may be configured to implement different disconnect behaviors for production vehicles versus development vehicles. The method, system, or electric vehicle may include performing a self-diagnostic check of the first and second disconnect mechanisms prior to vehicle operation, where the hardware logic circuits may comprise redundant circuitry for critical disconnect functions. The system may further include defaulting to a safe state if communication between hardware logic circuits is lost. All combinations (including the removal or addition of steps) in this paragraph or above paragraphs are contemplated in a manner that is consistent with the other portions of the detailed description.

For an electric vehicle implementation, the vehicle may include a high voltage system, a low voltage system, or a plurality of interconnected zone controllers implementing hardware logic circuits. The first disconnect mechanism may be coupled to at least one of the zone controllers, and the second disconnect mechanism may be coupled to at least one of the zone controllers. The hardware logic circuits may be configured to disable power to a first set of vehicle systems in response to activation of the first disconnect mechanism, and disable power to a second set of vehicle systems in response to activation of the second disconnect mechanism to fully power down the electric vehicle. All combinations (including the removal or addition of steps) in this paragraph or the above paragraphs are contemplated in a manner that is consistent with the other portions of the detailed description.

The term “or” is used inclusively unless otherwise disclosed. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for disconnecting power in a vehicle, comprising:
detecting activation of a first disconnect mechanism, wherein the first disconnect mechanism comprises a cut loop connector; and
disabling, based on the detecting of the activation of the first disconnect mechanism, power to a first set of vehicle systems using hardware logic circuits, wherein the first set of vehicle systems comprises high voltage contactors.

2. The method of claim 1, further comprising:
detecting activation of a second disconnect mechanism; and
in response to detecting activation of the second disconnect mechanism, disabling power to a second set of vehicle systems using hardware logic circuits to fully power down the vehicle.

3. The method of claim 2, wherein:
the second disconnect mechanism comprises disconnection of a low voltage battery terminal; and
the second set of vehicle systems comprises a low voltage DC-DC.

4. The method of claim 2, wherein:
the first disconnect mechanism comprises an emergency stop switch;
the first set of vehicle systems comprises a braking system and high voltage contactors;
the second disconnect mechanism comprises a low voltage battery disconnect switch; and
the second set of vehicle systems comprises a low voltage DC-DC converter.

5. The method of claim 1, wherein the hardware logic circuits are implemented in a plurality of interconnected zone controllers.

6. The method of claim 2, wherein disabling power to the first set of vehicle systems and the second set of vehicle systems occurs without software intervention.

7. The method of claim 2, further comprising configuring the hardware logic circuits to implement different disconnect behaviors for production vehicles versus development vehicles.

8. The method of claim 1, further comprising performing a self-diagnostic check of the first and second disconnect mechanisms prior to vehicle operation.

9. The method of claim 1, wherein the hardware logic circuits comprise redundant circuitry for critical disconnect functions.

10. The method of claim 1, further comprising defaulting to a safe state if communication between hardware logic circuits is lost.

11. A system for disconnecting power in a vehicle, comprising:
a plurality of interconnected zone controllers implementing hardware logic circuits;
a first disconnect mechanism coupled with at least a first zone controller; and
a second disconnect mechanism coupled to at least a second zone controller.

12. The system of claim 11, wherein the hardware logic circuits are configured to:
disable power to a first set of vehicle systems in response to activation of the first disconnect mechanism; and
disable power to a second set of vehicle systems in response to activation of the second disconnect mechanism to fully power down the vehicle.

13. The system of claim 11, wherein the first disconnect mechanism comprises a cut loop connector and the second disconnect mechanism comprises a low voltage battery terminal.

14. The system of claim 11, wherein the first disconnect mechanism comprises an emergency stop switch and the second disconnect mechanism comprises a low voltage battery disconnect switch.

15. The system of claim 11, wherein the plurality of interconnected zone controllers comprises an East zone controller, a West zone controller, and a South zone controller.

16. The system of claim 11, further comprising self-diagnostic circuitry configured to check integrity of the first and second disconnect mechanisms.

17. The system of claim 11, wherein the hardware logic circuits comprise redundant circuitry for critical disconnect functions.

18. An electric vehicle comprising:
a high voltage system;
a low voltage system;
a plurality of interconnected zone controllers implementing hardware logic circuits;
a first disconnect mechanism coupled to at least one of the plurality of interconnected zone controllers;
a second disconnect mechanism coupled to at least one of the plurality of interconnected zone controllers;
wherein the hardware logic circuits are configured to:
disable power to a first set of vehicle systems in response to activation of the first disconnect mechanism; and
disable power to a second set of vehicle systems in response to activation of the second disconnect mechanism to fully power down the electric vehicle.

19. The electric vehicle of claim 18, wherein:
the first disconnect mechanism comprises a cut loop connector;
the first set of vehicle systems comprises airbag systems and high voltage contactors;
the second disconnect mechanism comprises disconnection of a low voltage battery terminal; and
the second set of vehicle systems comprises a low voltage DC-DC converter.

20. The electric vehicle of claim 18, wherein:
the first disconnect mechanism comprises an emergency stop switch;
the first set of vehicle systems comprises a braking system and high voltage contactors;
the second disconnect mechanism comprises a low voltage battery disconnect switch; and
the second set of vehicle systems comprises a low voltage DC-DC converter.
